(19) United States
(12) Patent Application Publication
(10) Pub. No.: US 2003/0235192 A1
(43) Pub. Date: Dec. 25, 2003

(54) Adaptive delay-based overload control for communications systems

(76) Inventors: Masoud Sajadieh, Morganville, NJ (US); Mohsen Sarraf, Rumson, NJ (US); Kazem A. Sohraby, Lincroft, NJ (US)

Correspondence Address: HARNESS, DICKEY & PIERCE, P.L.C., P.O. Box 8910, Reston, VA, 20195, US

(21) Appl. No.: 10/175,288

(22) Filed: Jun. 20, 2002

(51) Int. Cl. H04L 12/56

(52) U.S. Cl. 370/389; 370/230

(57) ABSTRACT

A connection admission technique is presented that measures a delay of queries processed by a network system and allows queries to enter the network system based on a probabilistically determined variable. The technique converges the probabilistically determined variable to a performance criterion of the network system.

### BACKGROUND OF THE INVENTION

1. Field of the Invention

This invention relates generally to communications networks. More particularly, it relates to a control scheme to improve the control of Quality-of-Service (QoS) parameters in a packet or circuit network, e.g., in a voice-over-IP network.

2. Background of Related Art

Quality-of-Service (QoS) is one of the most important factors in communications and switching equipment. An important measure of QoS, especially in switching systems, with real-time applications support, is the processing delay that signaling messages encounter. Average processing delays are an important measure, particularly in multimedia applications, as the switching equipment is required to handle a significant amount of real-time traffic, e.g., voice and/or video.

Real-time signals are delay-sensitive in that they suffer performance and QoS degradation in the case of excessive and/or uncontrolled switching delays at any particular time in the communications network. While a predictable and consistent time delay through a network can be accommodated and associated with a particular level of QoS, a variable and inconsistent time delay becomes difficult and inefficient from a network standpoint because the QoS will likely be rated at the level of the worst case delay in the variable delay environment. Conventional networks tend to suffer from an inconsistent service delay due to conventional admittance techniques such as packet queuing.

Conventional networks that do employ technology to control overload conditions in a network often employ algorithms and/or devices that determine a specific control interval in order to provide an efficient admission technique. That is, a delay of queries or messages processed by a network system during a first control interval is measured. A number of queries admitted to the system during a second control interval after the first control interval is maintained based on the measured delay to target a desired delay for the communications system.

However, control intervals are not easily determined from system parameters even though network performance will be adversely affected if the intervals are not chosen carefully.

### SUMMARY OF THE INVENTION

An embodiment of the present invention provides an admission control scheme that grants entry of incoming queries, to a network system, based on probability. The scheme includes a Bernoulli random simulator that generates a Bernoulli random variable that controls whether a block/admit element blocks or admits an incoming query. The Bernoulli random simulator includes a feedback mechanism to converge the Bernoulli random variable to an optimum operation point for the network system.

### BRIEF DESCRIPTION OF THE DRAWINGS

Features and advantages of the present invention will become apparent to those skilled in the art from the following description with reference to the drawings, in which:

FIG. 1 illustrates a network system with an admission control scheme according to the present invention;

FIG. 2 illustrates an embodiment of the present invention where a query delay element is placed outside of the network system;

FIG. 3 illustrates operational elements of a blocking probability element according to the present invention; and

FIG. 4 illustrates a control-oriented viewpoint of the network system and the admission control scheme illustrated in FIG. 1.

### DETAILED DESCRIPTION OF ILLUSTRATIVE EMBODIMENTS

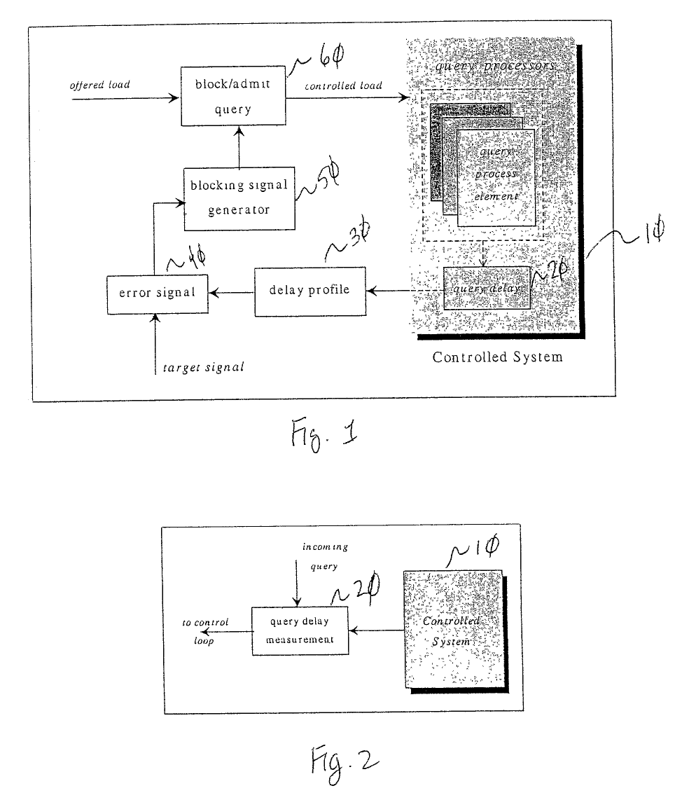

FIG. 1 illustrates a network system with the admission control scheme according to the present invention applied thereto. As is illustrated, a system 10 includes queries waiting for processing from operational elements of the system 10. The system 10 is a voice or data system that handles incoming data traffic. In particular, the system 10 may be any switching or traffic management fabric that handles control messages required to establish voice or data connections. Queries may flow into the system 10 during the entire period of an active data connection with the system 10. As the queries are processed, delay is encountered due to a workload currently in the system 10.

Query delay within the system 10 may be measured in various ways. The query delay with respect to queries being processed in the system 10 is represented with a query delay element 20. In particular, query delay in the system 10 may be measured by time stamping each query as it enters and exits the system 10. Alternatively, query delay may be measured by monitoring the processing delay of a series of periodically generated tokens that are passed through the system 10.

The actual object or element that measures the query delay of the system 10 may be either integral to the system 10, or separate and distinct therefrom. Such an arrangement is illustrated in FIG. 2, where the query delay element 20 is located outside of the system 10.

After measuring query delay in the system 10, a prescribed statistical profile of each of the measured delays is computed by a delay profile 30. Depending on a performance choice criterion based on system requirements, the profile is calculated using mean-sense or distribution-sense. These two methods are described in the following.

A. Control in the Mean-Sense

After measuring individual query delays, tⱼ, mean-sense delay is given by the following expression where n is a number of queries chosen to calculate the instantaneous (mean-sense) delay.

$${\overline{T}}_{j} = \frac{\sum {t}_{j}}{n}$$

This is then steered toward a target average delay threshold T.

If desired, the influence of sports or ‘outliers’, i.e., extreme delay values which may have been the result of sporadic system malfunctions, can be removed. Any suitable outlier removal technique may be employed, e.g., screening out individual delays outside a given range around the long-term trend of system delays. To achieve this, long-term delay average and variance of the delays should be monitored.

B. Control in the Distribution-Sense

In this method, a preset percentage value is given as Tₚ. Using this given value Tₚ, a percentage of delays greater than Tₚ below a given threshold of Pd is maintained. The actual delay percentile is given by the equation:

$${P}_{j} = \frac{\sum {I}_{j}}{n}$$

where Iⱼ is 1 if tⱼ≧Tₚ and 0 otherwise. It is then pushed to converge toward the percentile target of P_{d}. This is the preferred control approach if, for example, the design requirements call for the delay encountered by any query to be less than the threshold with, say, 90% confidence.

Depending on the control option, one of the above delay-based metrics is measured over the control interval. The error calculation module 40 in FIG. 1 receives this metric, and calculates the deviation from the desired target using the following equation:

εⱼ=d(M_{J},M_{d})

where Mⱼ is the observed metrics of the jth query, and M_{d} is the desired point of operation. These two quantities are dependent on the adopted control mode as follows.

Mⱼ=\overline{T}ⱼ and M_{d}=T for the mean-sense mode of control.

Mⱼ=Pⱼ and M_{d}=P_{d} for the distribution-sense mode of control.

A blocking signal generator 50, as illustrated in FIG. 1 accepts the error signal generated by the error calculation module 40. The blocking signal generator 50 is used to determine the likelihood of admitting a next query to the system 10. The output of the generator 50 is a binary value for indicating whether a next query should or should not be blocked by a block/admit element 60.

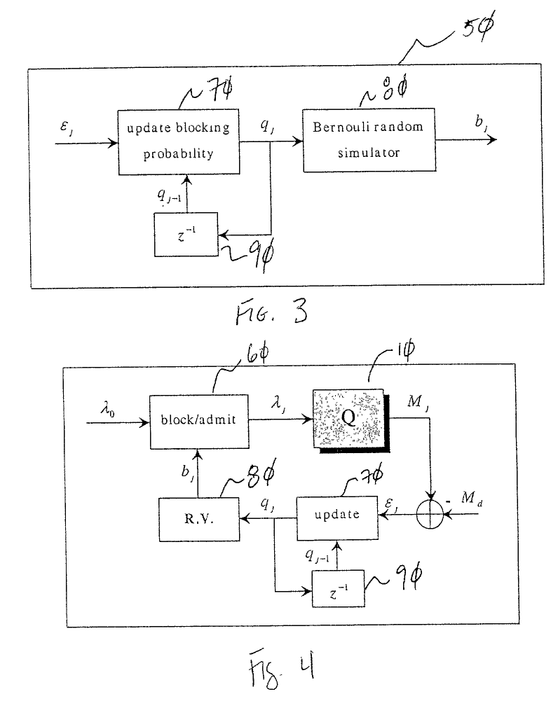

An example of operational elements/objects within the blocking generator is illustrated in FIG. 3. The error signal from the error calculation module 40 is received by an update blocking probability element 70 (discussed hereinafter).

An important aspect to decision making is to generate a Bernoulli random variable bⱼ using parameter qⱼ output from the update blocking probability element 70, which corresponds to the probability of a query drop. In essence, it is the outcome of an unfair coin toss experiment, in which turning up, for example, heads is tantamount to blocking the next query using the block/admit element 60.

A Bernoulli random simulator element 80 generates the Bernoulli random variable bⱼ with the probability of heads, qⱼ, as its input and will produce a 1 at the output if the outcome turns out to be heads and a 0 otherwise. That is, bⱼ=1 will block the next query from entry into the system 10 by way of the block/admit element 60. One simple technique to generate the binary bⱼ signal is to choose a random number within (0, 1) interval and output bⱼ=1 if the selected number is less than qⱼ. Over the long term and in stationary conditions, qⱼ will converge to the optimal blocking ratio which supports the desired performance criterion M_{d}.

System parameters and incoming traffic intensity vary with time and, as a result, the query blocking probability should adapt to the system variations. The update blocking probability element 70, responsible for updating the blocking ratio, receives input from the error calculation module 40 as well as the previous blocking probability, qⱼ₋₁. The latter is fed back to this block through a one-step memory block 90, as denoted by z⁻¹ in FIG. 3.

The blocking probability, qⱼ, regardless of its initial value, will gradually approach the limiting value, associated with the desired performance target as long as traffic statistics and system parameters remain intact. This implies that, for example in the mean-sense control, the average-delay vs. arrival-rate characteristic follows a predictable, repeatable trajectory. In most practical cases, query arrival tends to be nonstationary. Moreover processing elements exhibit variations in the service time due to software/hardware upgrades or abrupt component failures. A scalable solution which reacts gracefully to these and similar fluctuations is therefore necessary.

A simpler control-oriented viewpoint of that illustrated in FIG. 1 is shown in FIG. 4. In the figure, in terms of a first-order distance measure, it is clear:

εⱼ=Mⱼ−M_{d}.

Now denote by eⱼ=εⱼ/M_{d} the relative error at time j, then the blocking probability update is obtained from the following expression:

qⱼ=min(1,qⱼ₋₁+f(eⱼ)eⱼ)

where f(eⱼ) is the convergence parameter, governing the speed of convergence to the desired point of operation. The influence of the current error is also controlled by f(eⱼ) coefficient which, for negative error values, is given by

$$f ( e ) = - \frac{1}{{e}_{j}} {q}_{j - 1} e \leq 0$$

$$and f ( e ) = \{ \begin{matrix}0 & e \leq {th}_{0} \\ 0.1 & {th}_{0} < e \leq {th}_{1} \\ 0.9 & e > {th}_{1}\end{matrix}$$

for positive errors. Here th₀ and th₁ are thresholds, chosen based on the design requirements. If error signal is sufficiently small, qⱼ=qⱼ₋₁ and the current rate of blocking will be maintained. As can be seen, a negative error signal results in qⱼ=0, leading to the admission of the next query with a probability of one.

This update equation is one possibility among other update strategies that can be found. A different approach may involve application of various filtering techniques to qⱼ.

The specific value of particular thresholds are design parameters to be determined based on a particular application.

Note that while the disclosed embodiments relate to the admission in a control channel of a voice-over-IP system, the principles relate equally to packet systems such as asynchronous transfer mode (ATM) in general, telecommunications packet switching, the Internet in general, and/or voice-over-IP applications.

The elements discussed in conjunction with the embodiments of the present invention may be designed as individual network hardware elements. Alternatively, the elements may be embodied as a single hardware element. Furthermore, the elements may be embodied as software code and/or software objects.

While the invention has been described with reference to the exemplary embodiments thereof, those skilled in the art will be able to make various modifications to the described embodiments of the invention without departing from the true spirit and scope of the invention.

What is claimed is:

1. A connection admission technique, comprising:
allowing queries to enter a network system based on a probabilistically determined variable.

2. The connection admission technique according to claim 1, wherein the probabilistically determined variable is a probability of a query drop.

3. The connection admission technique according to claim 1, further comprising generating a binary value for either blocking or admitting a query into the network system.

4. The connection admission technique according to claim 3, wherein a query is permitted to enter the network system if the binary value is zero, and the query is prohibited from entering the network system if the binary value is one.

5. The connection admission technique according to claim 3, wherein the binary value is a Bernoulli random variable being one of zero and one.

6. The connection admission technique according to claim 1, further comprising converging the probabilistically determined variable to a predetermined performance criterion of the network system.

7. The connection admission technique according to claim 6, wherein converging converges the probabilistically determined variable to the predetermined performance criterion based at least on past probabilistically determined variables.

8. The connection admission technique according to claim 6, wherein converging includes using an error signal to control a speed the probabilistically determined variable converges to the predetermined performance criterion, the error signal being a value determined based on how far a current operating state of the network system has deviated from the predetermined performance criterion.

9. The connection admission technique according to claim 1, further comprising ignoring a number of queries during any given control interval when allowing queries to enter the network.

10. A query admission arrangement, comprising:
a signal generator for generating a numerical value based on a probabilistically determined variable; and
a block/admit element for receiving the numerical value, the block/admit element either permitting or prohibiting entry of a query into a system based on the numerical value.

11. The admission arrangement according to claim 10, wherein the probabilistically determined variable is based on a probability of a query drop.

12. The admission arrangement according to claim 10, wherein the numerical value is a Bernoulli random variable.

13. The admission arrangement according to claim 10, wherein the numerical value is one of a zero and a one.

14. The admission arrangement according to claim 10, wherein the signal generator includes a Bernoulli random simulator for generating the numerical value.

15. The admission arrangement according to claim 14, wherein the signal generator includes an update blocking probability element operationally linked to the Bernoulli random simulator, the update blocking probability element for generating the probabilistically determined variable.

16. The admission arrangement according to claim 15, wherein the signal generator includes a feedback element for providing the update blocking probability element with a past probabilistically determined variable.

17. The admission arrangement according to claim 16, wherein the probabilistically determined variable is based on a probability of a query drop.
